(19) United States
(12) Patent Application Publication
(10) Pub. No.: US 2025/0240395 A1
(43) Pub. Date: Jul. 24, 2025

(54) VIDEO SIGNAL TRANSMITTING DEVICE, VIDEO SIGNAL REPEATING DEVICE, AND VIDEO SIGNAL TRANSMITTING/RECEIVING SYSTEM

(71) Applicant: ROHM Co., Ltd., Kyoto (JP)

(72) Inventors: Naoki NISHITANI, Kyoto (JP); Yuki IMATOH, Kyoto (JP); Kento TAKAHASHI, Kyoto (JP)

(73) Assignee: ROHM Co., Ltd., Kyoto (JP)

(21) Appl. No.: 19/026,656

(22) Filed: Jan. 17, 2025

(30) Foreign Application Priority Data
Jan. 22, 2024 (JP) 2024-007647
Oct. 30, 2024 (JP) 2024-190911

(51) Int. Cl. H04N 9/78; H04N 9/67

(52) U.S. Cl. CPC H04N 9/78; H04N 9/67

(57) ABSTRACT

A video signal transmitting device includes: a YC conversion portion to which RAW data output from an imaging element by performing imaging is input, and configured to convert RAW data into YC data consisting of luminance data, first chrominance data, and second chrominance data for output; a digital-to-analog conversion portion configured to convert YC data output from the YC conversion portion into an analog signal for output; and an analog transmitting portion configured to transmit an analog signal converted by the digital-to-analog conversion portion to an external device.

### CROSS-REFERENCE TO RELATED APPLICATION

This application claims the priority benefits of Japanese application no. 2024-007647, filed on Jan. 22, 2024, and Japanese application no. 2024-190911, filed on Oct. 30, 2024. The entirety of the above-mentioned patent application is hereby incorporated by reference herein and made a part of this specification.

### BACKGROUND

### Technical Field

The disclosure relates to a video signal transmitting device, a video signal repeating device, and a video signal transmitting/receiving system.

### Description of Related Art

Patent Document 1 (Japanese Patent Application Laid-Open (JP-A) No. 2021-150791) describes an imaging device that digitally transmits RAW data output from an imaging element to an external device.

There is a demand to transmit a video signal obtained by an imaging element to an external device using analog transmission, which is less expensive compared to digital transmission.

However, in recent years, as imaging elements have become higher in resolution, the data amount of video signals has increased. As a result, there is a problem that it has become difficult to transmit video signals by analog transmission without degrading the image quality of the video signals obtained by the imaging element.

The disclosure, in consideration of the above circumstances, aims to provide a video signal transmitting device, a video signal repeating device, and a video signal transmitting/receiving system that suppress image quality degradation when transmitting a video signal obtained by an imaging element via analog transmission.

### SUMMARY

The video signal transmitting device of the disclosure includes: a YC conversion portion to which RAW data output from an imaging element by performing imaging is input, and configured to convert RAW data into YC data consisting of luminance data, first chrominance data, and second chrominance data for output; a digital-to-analog conversion portion configured to convert YC data output from the YC conversion portion into an analog signal for output; and an analog transmitting portion configured to transmit an analog signal converted by the digital-to-analog conversion portion to an external device.

The video signal repeating device of the disclosure includes: a receiving portion configured to receive an analog signal transmitted from a video signal transmitting device of the disclosure; an analog-to-digital conversion portion configured to convert an analog signal received by the receiving portion into YC data for output; and a RAW conversion portion configured to convert YC data output from the analog-to-digital conversion portion into RAW data for output.

The video signal transmitting/receiving system of the disclosure includes: a camera having the imaging element; a video signal transmitting device of the disclosure; a video signal repeating device of the disclosure; and a display device configured to display a video based on a signal output from the video signal repeating device.

### BRIEF DESCRIPTION OF THE DRAWINGS

FIG. 1 is a diagram showing a schematic configuration of a video signal transmitting/receiving system according to the first embodiment of the disclosure.

FIG. 2 is a diagram showing a schematic configuration of an imaging element.

FIG. 3 is a diagram showing signal formats in each portion of the video signal transmitting device and the video signal repeating device.

FIG. 4 is a diagram showing a functional configuration of the YC conversion portion in the video signal transmitting device according to the first embodiment.

FIG. 5 is a diagram for describing the YC conversion process.

FIG. 6 is a diagram for describing the RAW conversion process.

FIG. 7A is a diagram showing the state of change in signal format when transmitting a video signal from a video signal transmitting device of a comparative example to a video signal repeating device, and FIG. 7B is a diagram showing the state of change in signal format when transmitting a video signal from the video signal transmitting device of this embodiment to the video signal repeating device.

FIG. 8A is a diagram showing the state of change in signal format when transmitting a video signal from a video signal transmitting device of a comparative example to a video signal repeating device, and FIG. 8B is a diagram showing the state of change in signal format when transmitting a video signal from the video signal transmitting device of a modified example of this embodiment to the video signal repeating device.

FIG. 9A is a diagram showing the state of change in signal format when transmitting a video signal from a video signal transmitting device of a comparative example to a video signal repeating device, and FIG. 9B is a diagram showing the state of change in signal format when transmitting a video signal from the video signal transmitting device of a modified example of this embodiment to the video signal repeating device.

FIG. 10 is a diagram for describing signal degradation during analog transmission in the video signal transmitting/receiving system of the first embodiment.

FIG. 11 is a diagram showing a functional configuration of the YC conversion portion in the video signal transmitting device according to the second embodiment.

FIG. 12 is a diagram showing a functional configuration of the RAW conversion portion in the video signal transmitting device according to the second embodiment.

FIG. 13 is a diagram showing the state of change in signal state when transmitting a video signal from the video signal transmitting device of the second embodiment to the video signal repeating device.

FIG. 14 is a diagram for describing the rearrangement process of YC data in the video signal transmitting/receiving system of the third embodiment.

FIG. 15 is a diagram showing a modified example of the video signal repeating device.

FIG. 16 is a diagram showing a modified example of the video signal transmitting/receiving system.

FIG. 17 is a diagram showing a modified example of the display module device.

FIG. 18 is a diagram showing the hardware configuration of the YC conversion portion in the video signal transmitting device of the first embodiment.

FIG. 19 is a time chart for describing the process in the above-mentioned YC conversion portion.

FIG. 20 is a time chart for describing the process in the above-mentioned YC conversion portion.

FIG. 21 is a time chart for describing the process in the above-mentioned YC conversion portion.

FIG. 22 is a partially enlarged view of the time chart shown in FIG. 21.

FIG. 23 is a diagram showing the hardware configuration of the RAW conversion portion in the video signal repeating device of the first embodiment.

FIG. 24 is a time chart for describing the process in the above-mentioned RAW conversion portion.

FIG. 25 is a time chart for describing the process in the above-mentioned RAW conversion portion.

FIG. 26 is a time chart for describing the process in the above-mentioned RAW conversion portion.

### DESCRIPTION OF THE EMBODIMENTS

### First Embodiment

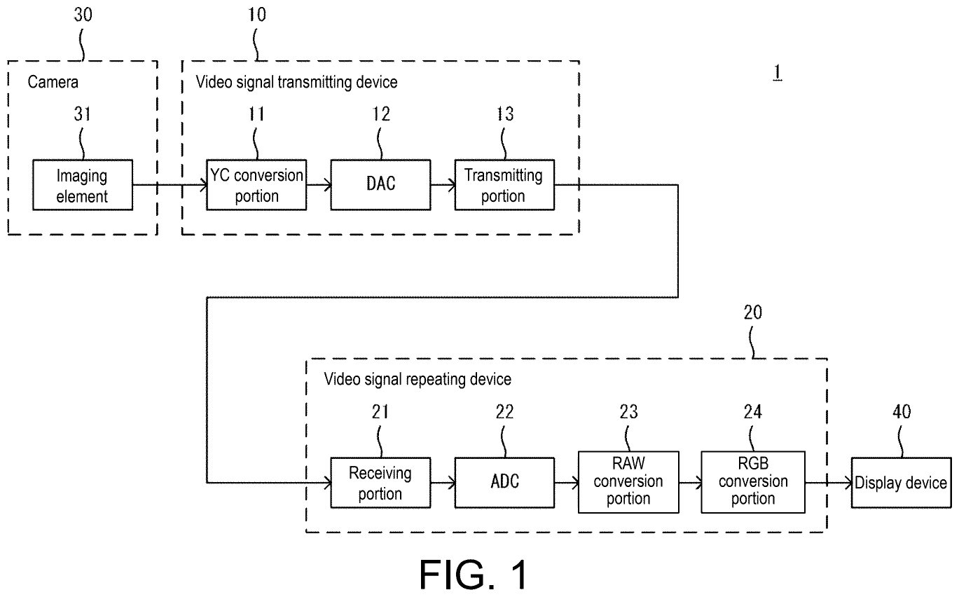

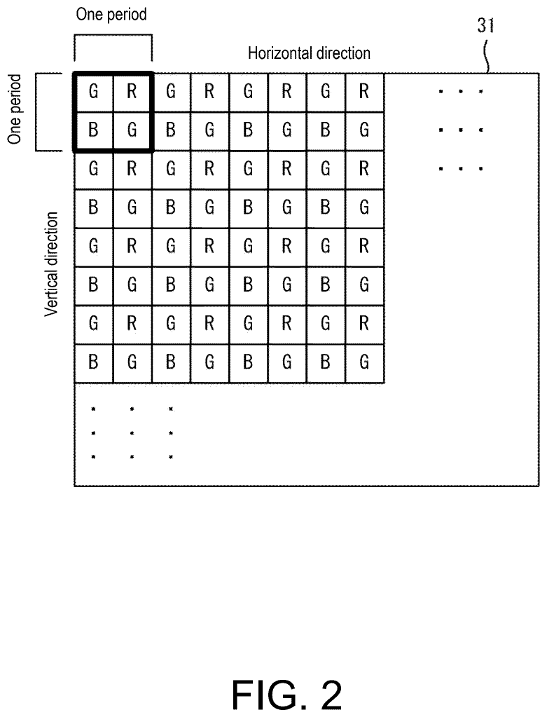

Next, an embodiment of the disclosure is described based on the drawings. FIG. 1 is a diagram showing a schematic configuration of a video signal transmitting/receiving system 1 according to the first embodiment of the disclosure. FIG. 2 is a diagram showing a schematic configuration of an imaging element.

As shown in FIG. 1, the video signal transmitting/receiving system 1 of the first embodiment includes a video signal transmitting device 10, a video signal repeating device 20, a camera 30, and a display device 40 that displays a video based on the signal output from the video signal repeating device 20.

The camera 30 includes an imaging element 31, an imaging lens (not shown), and the like. The imaging element 31 outputs RAW data generated by performing imaging. As shown in FIG. 2, the imaging element 31 of this embodiment has three color pixels, red pixels, green pixels, and blue pixels, arranged in a Bayer array. It is noted that, hereinafter, the red pixels may be referred to as pixels R, the green pixels as pixels G, and the blue pixels as pixels B.

In this Bayer array, one period in either the horizontal or vertical direction is 2 pixels, and one period in the other direction is also 2 pixels. The first row in the horizontal direction consists of pixel G and pixel R, while the second row in the horizontal direction consists of pixel B and pixel G, forming a unit of one period of the Bayer array with these four pixels. The imaging element 31 has a Bayer array in which this unit is continuously arranged in both vertical direction and horizontal direction.

It is noted that there is no particular restriction on the data amount of each pixel, and it may be set to any data amount according to the specifications of the imaging element 31. In this embodiment, as an example, the data amount of each pixel is set to 8 bits.

Returning to FIG. 1, the video signal transmitting device 10 includes a YC conversion portion 11, a DAC (Digital to Analog Converter) 12, and a transmitting portion 13. It is noted that the DAC 12 is an example of a digital-to-analog conversion portion in the technology of the disclosure.

The YC conversion portion 11 converts the RAW data output from the imaging element 31 into YC data for output. There is no particular restriction on the manner of YC conversion by the YC conversion portion 11, and it may be any manner such as YC444 conversion, YC422 conversion, or YC411 conversion. In this embodiment, as an example, the YC conversion portion 11 performs YC422 conversion.

The DAC 12 converts the YC data output from the YC conversion portion 11 into an analog signal for output. The transmitting portion 13 transmits the analog signal converted by the DAC 12.

The video signal repeating device 20 includes a receiving portion 21, an ADC (Analog to Digital Converter) 22, a RAW conversion portion 23, and an RGB conversion portion 24. The ADC 22 is an example of an analog-to-digital conversion portion in the technology of the disclosure.

The receiving portion 21 receives the analog signal transmitted from the video signal transmitting device 10. The ADC 22 converts the analog signal received by the receiving portion 21 into digital data for output. The RAW conversion portion 23 converts the digital data output from the ADC 22 into RAW data by performing a process that is the reverse of the YC conversion portion 11 of the video signal transmitting device 10 for output. The RGB conversion portion 24 performs RGB conversion on the RAW data output from the RAW conversion portion 23 to obtain RGB data.

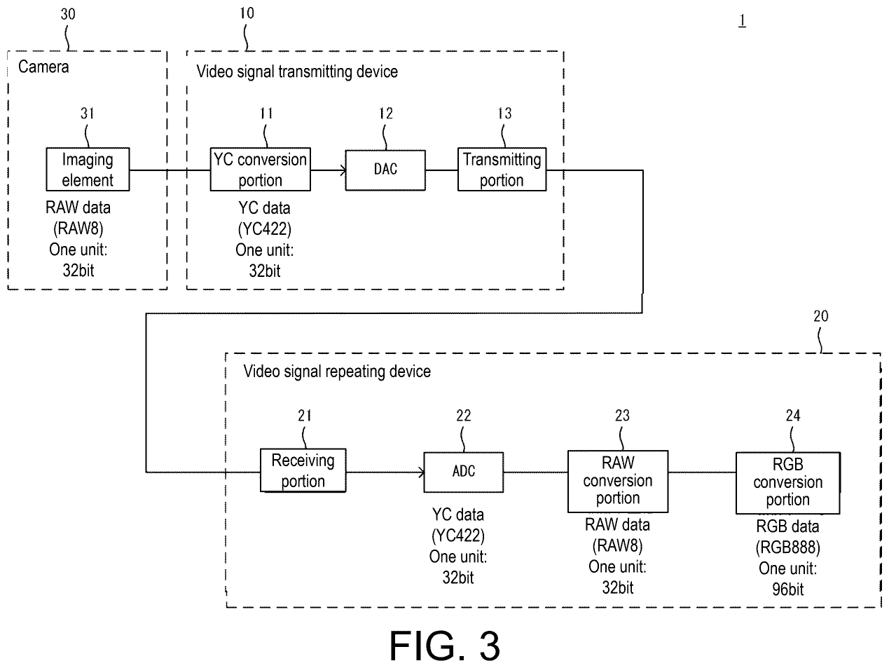

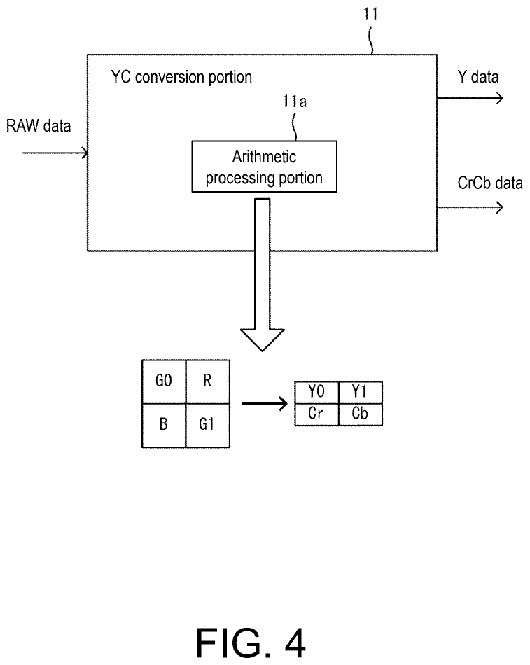

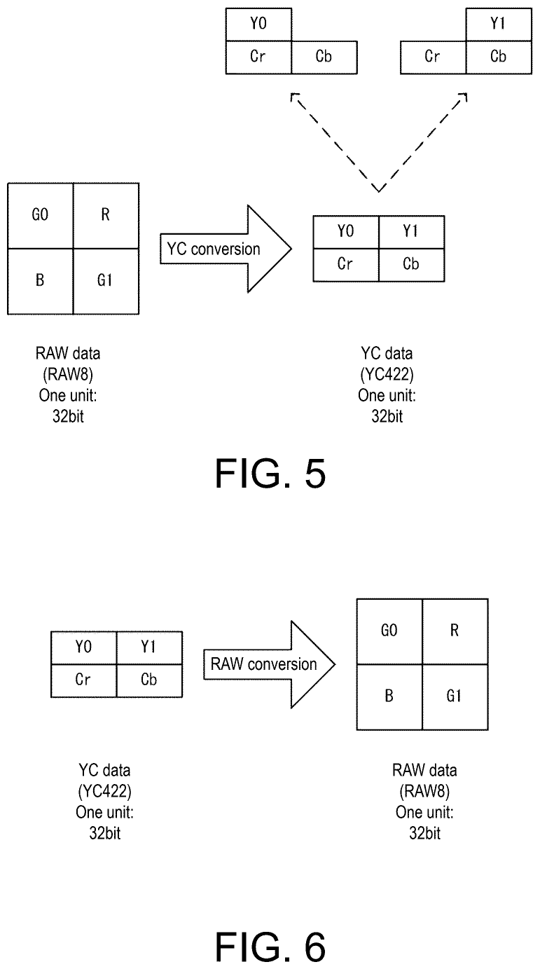

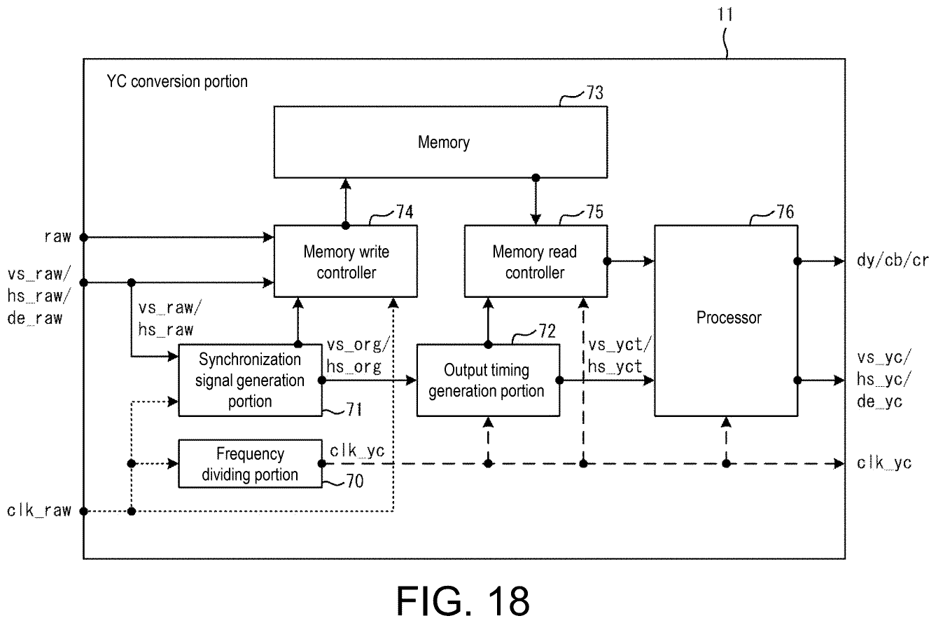

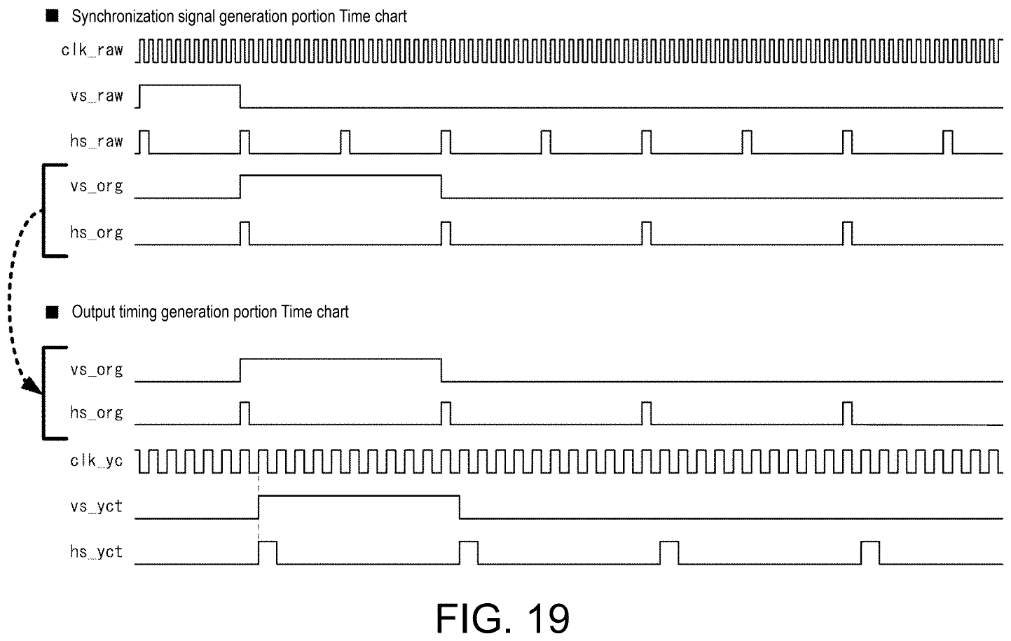

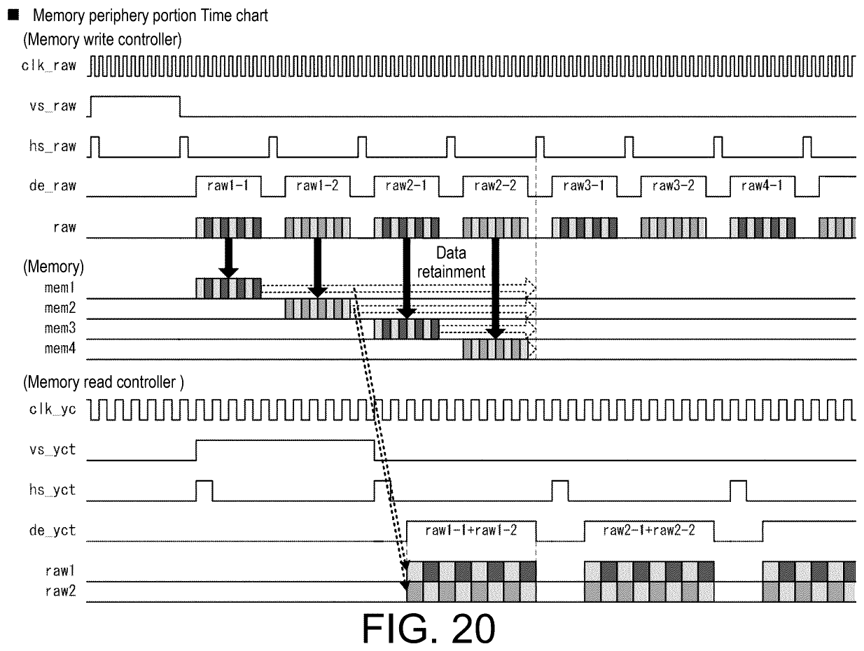

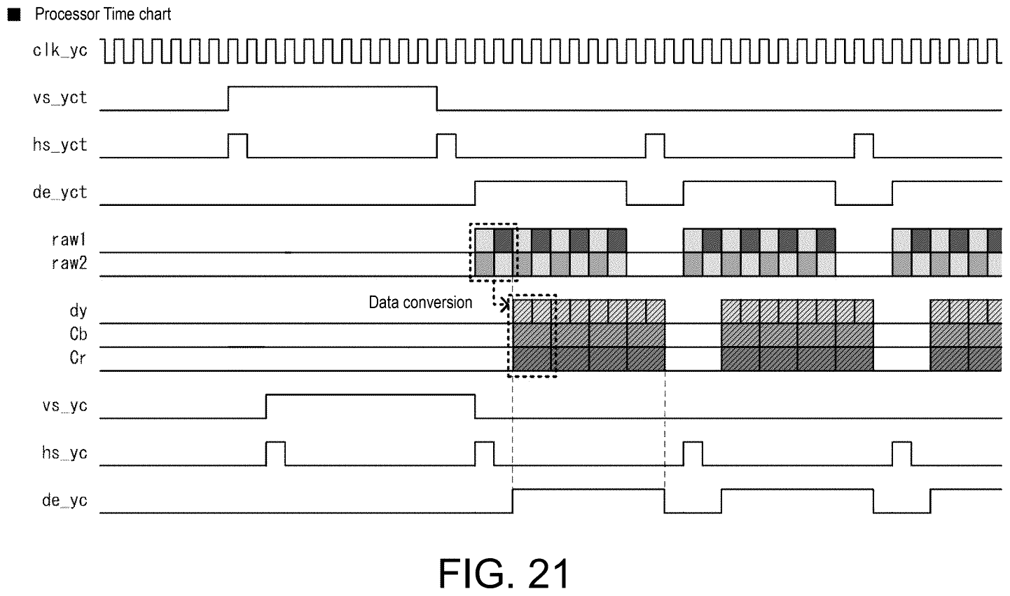

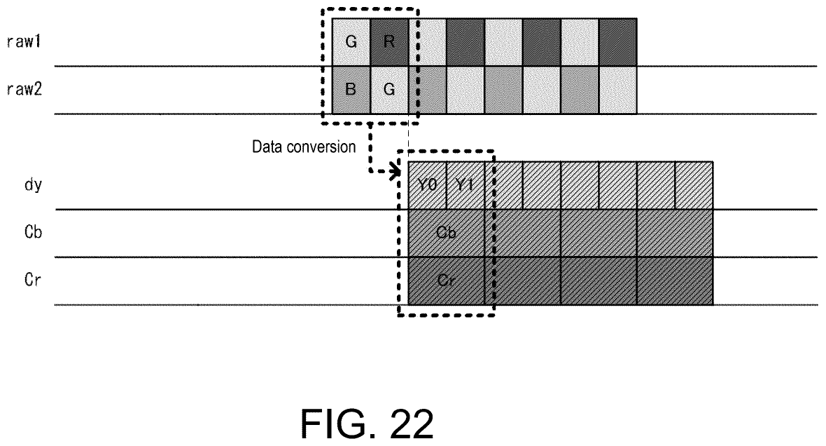

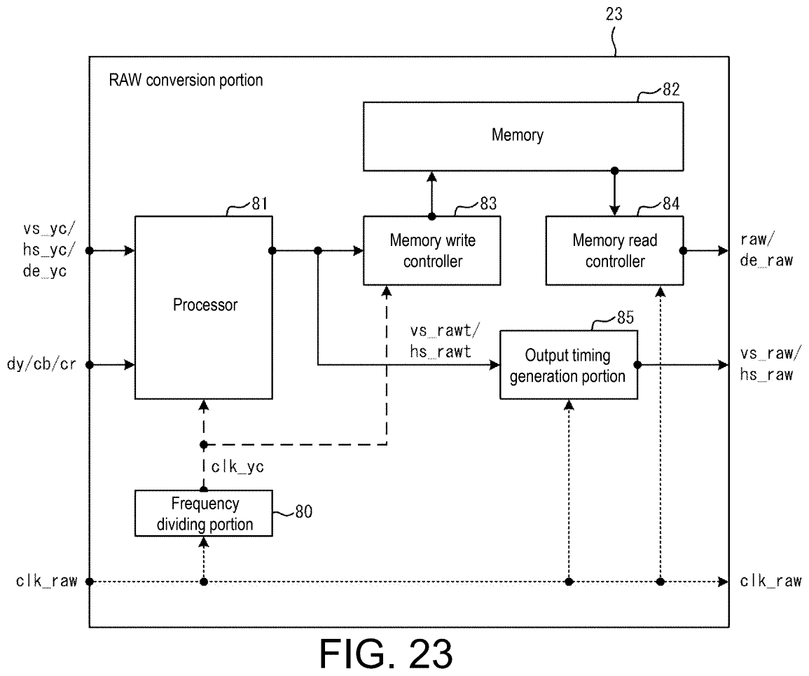

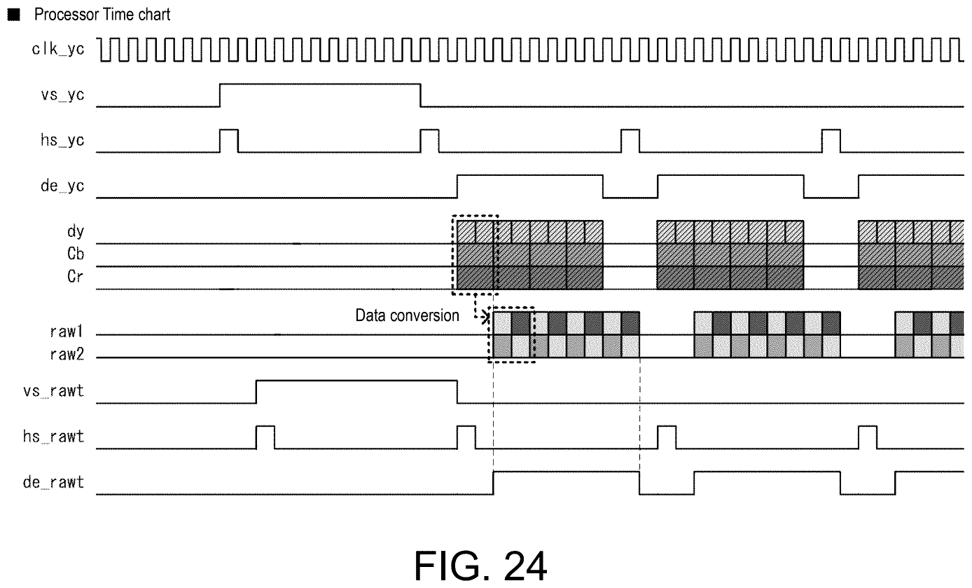

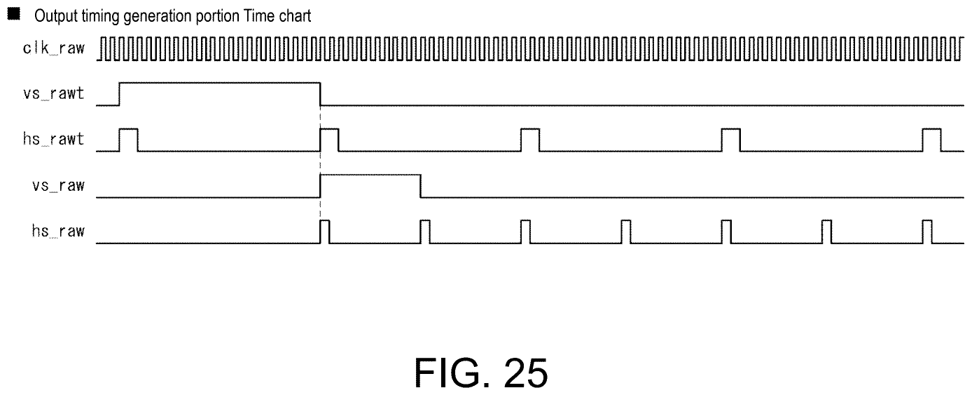

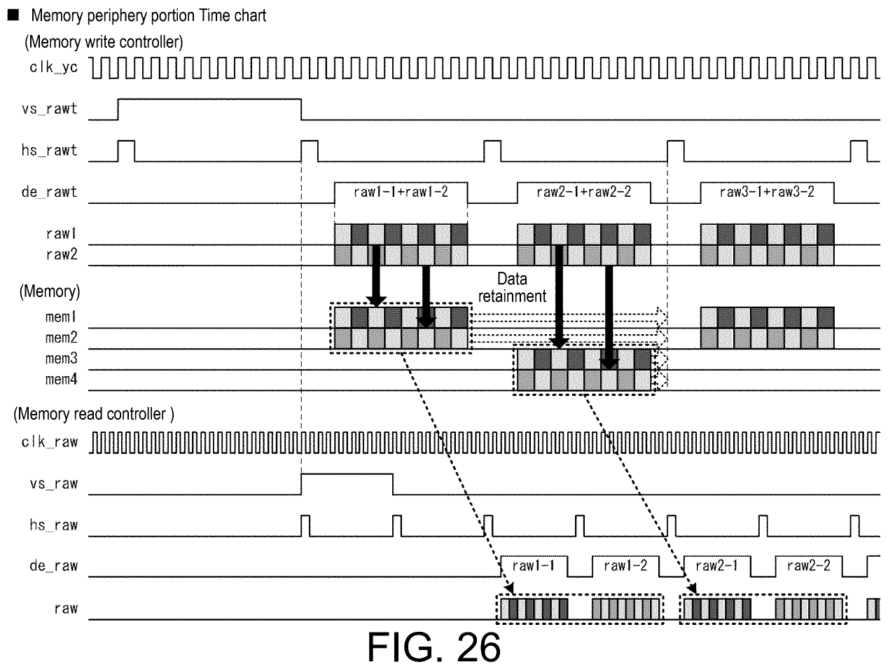

Next, the process during analog signal transmission in the video signal transmitting device 10 of the video signal transmitting/receiving system 1 of this embodiment is described. FIG. 3 is a diagram showing signal formats in each portion of the video signal transmitting device 10 and the video signal repeating device 20. FIG. 18 is a diagram showing the hardware configuration of the YC conversion portion 11. FIG. 19, FIG. 20, and FIG. 21 are time charts for describing the process in the YC conversion portion 11. FIG. 22 is a partial enlarged view of the time chart shown in FIG. 21. FIG. 4 is a diagram showing the functional configuration of the YC conversion portion 11 in the video signal transmitting device 10 of this embodiment. FIG. 5 is a diagram for describing the YC conversion process. FIG. 6 is a diagram for describing the RAW conversion process. FIG. 23 is a diagram showing the hardware configuration of the RAW conversion portion 23. FIG. 24, FIG. 25, and FIG. 26 are time charts for describing the process in the RAW conversion portion 23.

As shown in FIG. 3, the video signal transmitting device 10 of this embodiment converts the RAW data output from the imaging element 31 into YC data by the YC conversion portion 11, converts the converted YC data into an analog signal by the DAC 12, and transmits the same as an analog signal from the transmitting portion 13.

The data amount for 1 pixel in the RAW data output from the imaging element 31 is 8 bits, and the data amount for 1 unit corresponding to 1 period of the Bayer array is 32 bits.

The YC conversion portion 11 includes an arithmetic processing portion 11a, as shown in FIG. 4. The YC conversion portion 11 is implemented, for example, by the following hardware configuration.

The YC conversion portion 11 includes, as shown in FIG. 18, a frequency dividing portion 70, a synchronization signal generation portion 71, an output timing generation portion 72, a memory 73, a memory write controller 74, a memory read controller 75, and a processor 76.

The frequency dividing portion 70 divides the frequency of the RAW clock signal clk_raw corresponding to the RAW data raw input from an external device of the YC conversion portion 11 by ½, and generates a YC clock signal clk_yc corresponding to the YC data.

The synchronization signal generation portion 71 generates an internal process vertical synchronization signal vs_org and a horizontal synchronization signal hs_org based on the vertical synchronization signal vs_raw, horizontal synchronization signal hs_raw, and display period signal de_raw of the RAW data raw input from an external device of the YC conversion portion 11, and the RAW clock signal clk_raw, and outputs them to the output timing generation portion 72 and the memory write controller 74.

The output timing generation portion 72 generates a temporary vertical synchronization signal vs_yct and a temporary horizontal synchronization signal hs_yct for the YC data dy/dc/cr based on the vertical synchronization signal vs_org and the horizontal synchronization signal hs_org, and outputs them to the memory read controller 75 and the processor 76.

The memory 73 stores the RAW data raw input from an external device of the YC conversion portion 11.

The memory write controller 74 controls the writing of the RAW data raw to the memory 73.

The memory read controller 75 controls the reading of the RAW data raw from the memory 73.

The processor 76 converts the RAW data raw to YC data dy/dc/cr, and outputs the same to the external device along with the vertical synchronization signal vs_yc, horizontal synchronization signal hs_yc, and display period signal de_yc of the YC data dy/dc/cr.

The following describes the process in the YC conversion portion 11.

First, as shown in FIG. 19, the synchronization signal generation portion 71 generates a vertical synchronization signal vs_org by doubling the pulse width and pulse period of the vertical synchronization signal vs_raw of the RAW data raw in synchronization with the RAW clock signal clk_raw. Further, the synchronization signal generation portion 71 generates a horizontal synchronization signal hs_org by doubling the pulse period of the horizontal synchronization signal hs_raw of the RAW data raw in synchronization with the RAW clock signal clk_raw.

Next, the output timing generation portion 72 generates a temporary vertical synchronization signal vs_yct for the YC data by adjusting the timing of the vertical synchronization signal vs_org in synchronization with the YC clock signal clk_yc. Further, the output timing generation portion 72 generates a temporary horizontal synchronization signal hs_yct for the YC data by adjusting the timing of the horizontal synchronization signal hs_org and doubling its pulse width in synchronization with the YC clock signal clk_yc.

Next, as shown in FIG. 20, the memory write controller 74 writes the RAW data raw to the memory 73 in synchronization with the RAW clock signal clk_raw.

In detail, the RAW data raw is arranged with GR data lines and BG data lines alternating as horizontal direction data lines. Further, the memory 73 has four lines of recording areas: mem1, mem2, mem3, and mem4.

The memory write controller 74 writes, for every four data lines in the horizontal direction, the first GR data line to mem1, the second BG data line to mem2, the third GR data line to mem3, and the fourth BG data line to mem4.

The GR data line written to mem1, the BG data line written to mem2, the GR data line written to mem3, and the BG data line written to mem4 are retained until the writing of the next four data lines begins.

Next, the memory write controller 74 reads out the RAW data raw from the memory 73 in synchronization with the YC clock signal clk_yc.

In detail, the memory write controller 74 reads out from the memory 73 the GR data line written to mem1 and the BG data line written to mem2, combining them as RAW data raw1 and raw2 for two rows in the horizontal direction. Further, the memory write controller 74 reads out from the memory 73 the GR data line written to mem3 and the BG data line written to mem4, combining them as RAW data raw1 and raw2 for two rows in the horizontal direction.

Next, as shown in FIG. 21, the processor 76 converts the RAW data raw1 and raw2 for two rows in the horizontal direction into YC data dy/dc/cr in synchronization with the YC clock signal clk_yc.

In detail, as shown in FIG. 22, the processor 76 converts the RAW data raw1 and raw2 for two rows in the horizontal direction into YC data dy/dc/cr for each data of unit corresponding to one period of the Bayer array consisting of GRBG. The details of the conversion process are described in detail in a later section.

The processor 76 outputs the converted YC data dy/dc/cr to the external device, along with the vertical synchronization signal vs_yc, horizontal synchronization signal hs_yc, and display period signal de_yc of this YC data dy/dc/cr.

As described above, RAW data is input to the YC conversion portion 11, and in the arithmetic processing portion 11a, the input RAW data is converted to YC422 to generate YC data, which is then separated into Y data (i.e., luminance data) and CbCr data (i.e., chrominance data) for output.

In detail, as shown in FIG. 5, the YC conversion portion 11 converts RAW data to YC data by YC422 conversion for each unit consisting of 4 pixels (2 pixels in the horizontal direction×2 pixels in the vertical direction) and obtains YC data for 2 pixels aligned in the horizontal direction, consisting of 4 signals: Y data of the first pixel and Y data of the second pixel in order from the beginning in one of the two rows in the horizontal direction, and Cb data and Cr data common to the first pixel and second pixel in the other of the two rows in the horizontal direction.

The data amount for 1 pixel in the YC data converted from 1 unit of RAW data is 16 bits, and the data amount for 2 pixels corresponding to 1 unit of the Bayer array is 32 bits.

There are no particular restrictions on the method of YC422 conversion at this time, and any method may be used, such as various existing conversion formulas or the simplified conversion formulas described below. In this embodiment, as an example, YC422 conversion is performed using the following simplified conversion formulas.

$$Y 0 = G 0$$

$$Y 1 = G 1$$

$$G = ( G 0 + G 1 ) / 2$$

$$Y = ( 5 G + 2 R + B ) / 8$$

$$Cb = B - Y$$

$$Cr = R - Y$$

As described above, the data amount for 4 pixels corresponding to 1 unit of the Bayer array in RAW data is 32 bits, and since the data amount for 2 pixels corresponding to 1 unit of the Bayer array in YC data is 32 bits, the data amount does not change before and after YC422 conversion of RAW data. In other words, no data degradation occurs due to the YC422 conversion in the YC conversion portion 11.

Returning to FIG. 3, in the disclosure, the video signal repeating device 20 receives the analog signal transmitted from the video signal transmitting device 10 by the receiving portion 21, converts the received analog signal to digital data by the ADC 22, converts the converted digital data to RAW data by the RAW conversion portion 23, and performs RGB conversion on the converted RAW data by the RGB conversion portion 24 to obtain RGB data.

The RAW conversion portion 23 converts the digital data output from the ADC 22 to RAW data by performing a process that is the reverse of the YC conversion portion 11 in the video signal transmitting device 10. As an example, the RAW conversion portion 23 is implemented by the following hardware configuration.

The RAW conversion portion 23 includes, as shown in FIG. 23, a frequency dividing portion 80, a processor 81, a memory 82, a memory write controller 83, a memory read controller 84, and an output timing generation portion 85.

The frequency dividing portion 80 divides the frequency of the RAW clock signal clk_raw corresponding to the RAW data raw input from an external device of the RAW conversion portion 23 by ½ to generate the YC clock signal clk_yc corresponding to the YC data.

The processor 81, based on the YC data dy/dc/cr, the vertical synchronization signal vs_yc, horizontal synchronization signal hs_yc, and display period signal de_yc of this YC data dy/dc/cr, and the YC clock signal clk_yc, converts the YC data dy/dc/cr to RAW data raw, and generates a temporary vertical synchronization signal vs_rawt and a temporary horizontal synchronization signal hs_rawt for the RAW data raw, and outputs them to the memory write controller 83 and the output timing generation portion 85.

The memory 82 stores the RAW data raw input from the processor 81.

The memory write controller 83 controls the writing of the RAW data raw to the memory 82.

The memory read controller 84 controls the reading of the RAW data raw from the memory 82.

The output timing generation portion 85 generates the vertical synchronization signal vs_raw and horizontal synchronization signal hs_raw for the RAW data raw based on the temporary vertical synchronization signal vs_rawt and temporary horizontal synchronization signal hs_rawt of the RAW data raw, and outputs them to an external device.

The following describes the process in the RAW conversion portion 23.

First, as shown in FIG. 24, the processor 81, in synchronization with the YC clock signal clk_yc, converts the YC data dy/dc/cr into RAW data raw1 and raw2 of two rows in the horizontal direction. The details of the conversion process are described in detail in a later section.

The processor 81 generates the temporary vertical synchronization signal vs_rawt, temporary horizontal synchronization signal hs_rawt, and temporary display period signal de_rawt for the converted RAW data raw1 and raw2 of two rows in the horizontal direction, and outputs them along with the RAW data raw1 and raw2 to the memory write controller 83 and the output timing generation portion 85.

Next, as shown in FIG. 25, the output timing generation portion 85, in synchronization with the RAW clock signal clk_raw, adjusts the timing of the temporary vertical synchronization signal vs_rawt while reducing its pulse width and pulse period by half to generate the vertical synchronization signal vs_raw for the RAW data raw. Further, the output timing generation portion 85, in synchronization with the RAW clock signal clk_raw, adjusts the timing of the temporary horizontal synchronization signal hs_rawt while reducing its pulse width and pulse period by half to generate the horizontal synchronization signal hs_raw for the RAW data raw.

Next, as shown in FIG. 26, the memory write controller 83, in synchronization with the YC clock signal clk_yc, writes the RAW data raw1 and raw2 of two rows in the horizontal direction to the memory 82.

Specifically, the memory 82 has four lines of recording areas: mem1, mem2, mem3, and mem4.

The memory write controller 83 writes, for each combination of two data in the RAW data raw1 and raw2 of two rows in the horizontal direction, the GR data line of the first data combination to mem1, the BG data line of the first data combination to mem2, the GR data line of the second data combination to mem3, and the BG data line of the second data combination to mem4.

The GR data line written to mem1, the BG data line written to mem2, the GR data line written to mem3, and the BG data line written to mem4 are retained until the writing of the next two data combinations begins.

Next, the memory read controller 84, in synchronization with the RAW clock signal clk_raw, reads out the RAW data raw1 and raw2 of two rows in the horizontal direction from the memory 82.

Specifically, the memory read controller 84 sequentially reads out the GR data line written to mem1 and the BG data line written to mem2, and converts them into RAW data raw of one row in the horizontal direction. Further, the memory read controller 84 sequentially reads out the GR data line written to mem3 and the BG data line written to mem4, and converts them into RAW data raw of one row in the horizontal direction.

As described above, the RAW conversion portion 23 generates RAW data for four pixels from YC data for two pixels for each unit.

In this embodiment, since the YC conversion portion 11 of the video signal transmitting device 10 performs YC422 conversion using the above-mentioned simplified conversion formula, the RAW conversion portion 23 may convert to RAW data using the following simplified inverse conversion formula.

$$G 0 = Y 0$$

$$G 1 = Y 1$$

$$G = ( G 0 + G 1 ) / 2$$

$$Y = ( 5 G + 2 R + B ) / 8$$

$$B = Cb - Y$$

$$R = Cr - Y$$

In the video signal repeating device 20, the data amount for two pixels corresponding to one period of the Bayer array in YC data is 32 bits, and the data amount for four pixels corresponding to one period of the Bayer array in RAW data is 32 bits, which is the same as the data amount of each data in the video signal transmitting device 10.

The video signal repeating device 20, after obtaining the RAW data, performs RGB conversion on the RAW data by the RGB conversion portion 24 to obtain RGB data. In the video signal repeating device 20 of this embodiment, the RGB conversion portion 24 performs demosaic process along with RGB conversion when converting RAW data to RGB. The demosaic process is a process of complementing pixels by referring to color information of pixels adjacent to each pixel.

Specifically, RGB conversion generates R data, G data, and B data of 8 bits each by interpolating data from surrounding pixels for each pixel of RAW data. As a result, in RGB data, R data, G data, and B data are included within one pixel.

Thus, the data amount for one pixel in the RGB data obtained by RGB conversion increases to 24 bits, and the data amount for four pixels corresponding to one unit of the Bayer array becomes 96 bits.

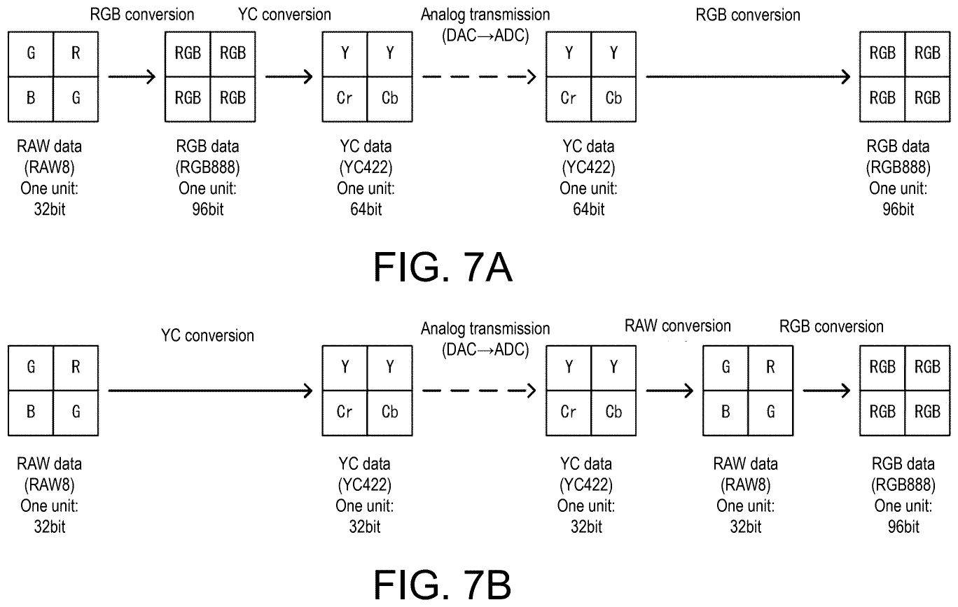

Next, the effects of the video signal transmitting/receiving system 1 of this embodiment is described. FIG. 7A is a diagram showing the state of change in signal format when transmitting a video signal from a video signal transmitting device of a comparative example to a video signal repeating device, and FIG. 7B is a diagram showing the state of change in signal format when transmitting a video signal from the video signal transmitting device 10 of this embodiment to the video signal repeating device 20.

First, as a comparative example, a general video signal transmitting/receiving system that performs analog transmission is described. As shown in FIG. 7A, in the video signal transmitting/receiving system of the comparative example, the video signal transmitting device converts RAW data to RGB data by RGB conversion, converts the converted RGB data to YC data by YC422 conversion, converts the generated YC data to analog signals, and performs analog transmission.

Here, the data amount for four pixels corresponding to one unit of the Bayer array in RAW data is 32 bits, the data amount for four pixels corresponding to one unit of the Bayer array in RGB data is 96 bits, and the data amount for four pixels corresponding to one unit of the Bayer array in YC data is 64 bits.

Further, the video signal repeating device in the video signal transmitting/receiving system of the comparative example performs digital conversion on the received analog signals to obtain YC data, and then performs RGB conversion on the obtained YC data to obtain RGB data.

Here, the data amount for four pixels corresponding to one unit of the Bayer array in YC data is 64 bits, and the data amount for four pixels corresponding to one unit of the Bayer array in RGB data is 96 bits.

Next, the video signal transmitting/receiving system 1 of this embodiment is described. As shown in FIG. 7B, the video signal transmitting device 10 in the video signal transmitting/receiving system 1 of this embodiment performs YC422 conversion on RAW data to generate YC data, converts the generated YC data to analog signals, and performs analog transmission.

Here, the data amount for four pixels corresponding to one unit of the Bayer array in RAW data is 32 bits, and as described earlier, the data amount for two pixels corresponding to one unit of the Bayer array in YC data is 32 bits.

Further, the video signal repeating device 20 in the video signal transmitting/receiving system 1 of this embodiment performs digital conversion on the received analog signals to obtain YC data, performs RAW conversion on the obtained YC data to obtain RAW data, and converts the obtained RAW data to RGB data by RGB conversion.

Here, the data amount for two pixels corresponding to one unit of the Bayer array in YC data is 32 bits, the data amount for four pixels corresponding to one unit of the Bayer array in RAW data is 32 bits, and the data amount for four pixels corresponding to one unit of the Bayer array in RGB data is 96 bits.

Comparing the video signal transmitting/receiving system 1 of this embodiment with the video signal transmitting/receiving system of the comparative example, the data amount for four pixels corresponding to one unit of the Bayer array in the RGB data finally obtained in the video signal repeating device 20 of the video signal transmitting/receiving system 1 of this embodiment is 96 bits, which is the same as the data amount for four pixels corresponding to one unit of the Bayer array in the RGB data finally obtained in the video signal repeating device 20 of the video signal transmitting/receiving system of the comparative example.

However, in the video signal transmitting device 10 of the video signal transmitting/receiving system 1 of this embodiment, the data amount for two pixels corresponding to one unit of the Bayer array in the YC data immediately before conversion to analog signals is 32 bits, while in the video signal transmitting device of the video signal transmitting/receiving system of the comparative example, the data amount for four pixels corresponding to one unit of the Bayer array in the YC data immediately before conversion to analog signals is 64 bits.

In other words, according to the video signal transmitting/receiving system 1 of the disclosure, when transmitting a video signal with an equivalent data amount to that of the video signal transmitting/receiving system of the comparative example, the data amount of the analog signals transmitted from the video signal transmitting device 10 may be reduced to half the data amount of the video signal transmitting/receiving system of the comparative example.

Thus, according to the video signal transmitting/receiving system 1 of the disclosure, in the case of analog transmission of video signals, it is possible to transmit and receive while suppressing image quality degradation.

Further, according to the video signal transmitting device 10 of the disclosure, in the case of analog transmission of video signals, it is possible to transmit while suppressing image quality degradation.

Further, according to the video signal repeating device 20 of the disclosure, in the case of analog transmission of video signals, it is possible to receive analog signals with suppressed image quality degradation.

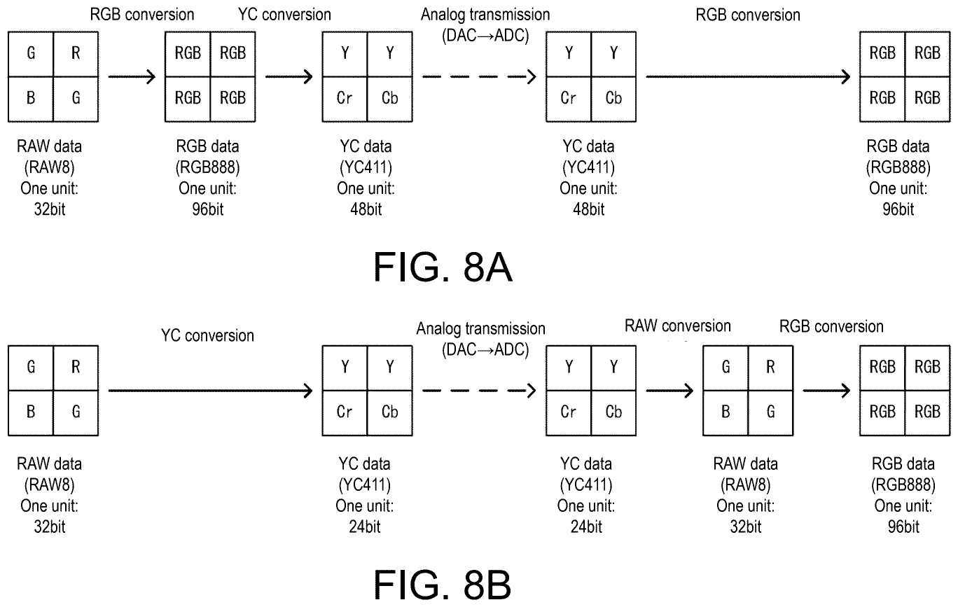

It is noted that in the above-described embodiment, the YC conversion portion 11 of the video signal transmitting device 10 is described as performing YC422 conversion, but as shown in FIG. 8A and FIG. 8B, it may also perform YC411 conversion.

In the case of performing YC411 conversion as well, when transmitting a video signal with an equivalent data amount to that of the video signal transmitting/receiving system of the comparative example, the data amount of the analog signals transmitted from the video signal transmitting device 10 may be reduced to half the data amount of the video signal transmitting/receiving system of the comparative example.

Further, in the case of performing YC411 conversion, compared to performing YC422 conversion, although the image quality deteriorates, the data amount of the analog signals transmitted from the video signal transmitting device 10 may be reduced to 24 bits.

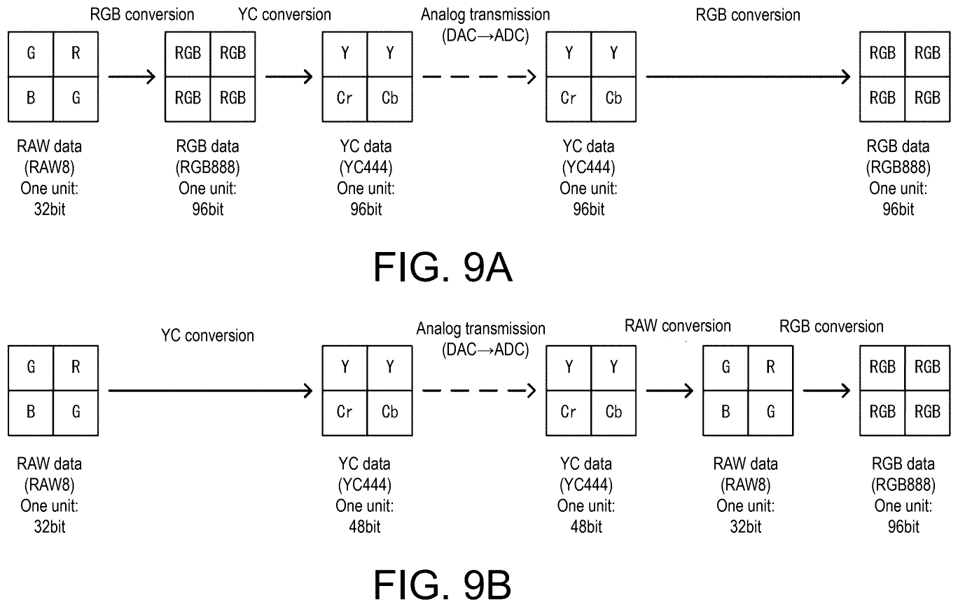

Further, regarding the YC conversion portion 11 of the video signal transmitting device 10, as shown in FIG. 9A and FIG. 9B, it may also perform YC444 conversion.

In the case of performing YC444 conversion as well, when transmitting a video signal with an equivalent data amount to that of the video signal transmitting/receiving system of the comparative example, the data amount of the analog signals transmitted from the video signal transmitting device 10 may be reduced to half the data amount of the video signal transmitting/receiving system of the comparative example.

Further, in the case of performing YC444 conversion, compared to performing YC422 conversion, although the data amount of the analog signals transmitted from the video signal transmitting device 10 increases to 48 bits, the image quality may be improved.

Further, the mode of YC conversion by the YC conversion portion 11 may be in a mode other than the above-mentioned YC444 conversion, YC422 conversion, or YC411 conversion.

### Second Embodiment

Next, the video signal transmitting/receiving system of the second embodiment is described. In the video signal transmitting/receiving system of this embodiment, the process of the YC conversion portion 11 of the video signal transmitting device 10 and the process of the RAW conversion portion 23 of the video signal repeating device 20 differ from those of the video signal transmitting/receiving system 1 of the first embodiment. In the video signal transmitting/receiving system of this embodiment, the same reference numbers are assigned to the same components as in the video signal transmitting/receiving system 1 of the first embodiment, and descriptions are omitted unless particularly necessary.

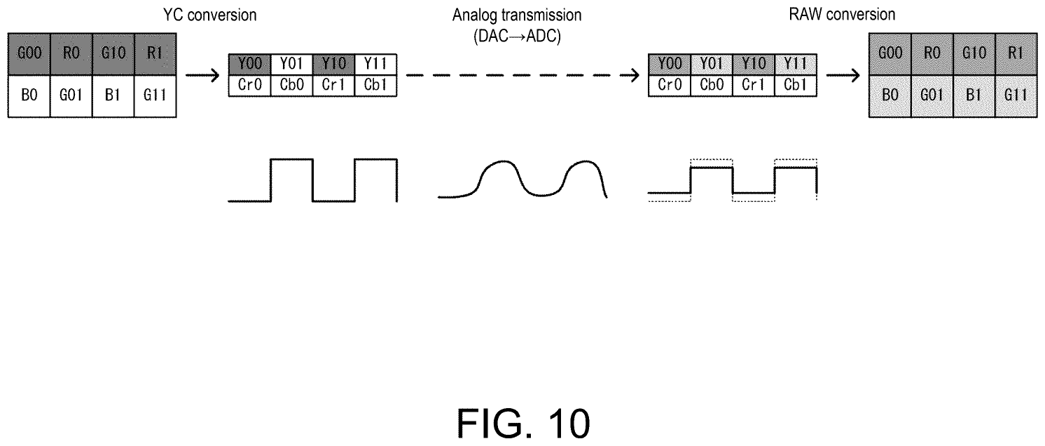

FIG. 10 is a diagram for describing signal degradation during analog transmission in the video signal transmitting/receiving system of the first embodiment.

In the case of performing YC conversion of RAW data generated by an imaging element 31 with a Bayer array to YC data for analog transmission, as shown in FIG. 10, when there is a large luminance difference between the luminance of a certain horizontal line in the RAW data and the luminance of a horizontal line which is adjacent to that horizontal line in the vertical direction, steep changes in luminance occur continuously in the YC data.

The reason for this phenomenon is that green pixels, which have a high contribution to luminance, are arranged zigzag across two rows in the horizontal direction.

In the video signal transmitting device 10, when such YC data with continuous steep changes in luminance is converted to an analog signal by the DAC 12, signal degradation becomes more likely to occur. Further, in the video signal repeating device 20, when such an analog signal with continuous steep changes in luminance is converted to digital data by the ADC 22 to obtain YC data, signal degradation also becomes more likely to occur.

As a result, in the video signal repeating device 20, when YC data is RAW converted to obtain RAW data, there is a risk of problems such as edge blurring and bleeding at boundary areas.

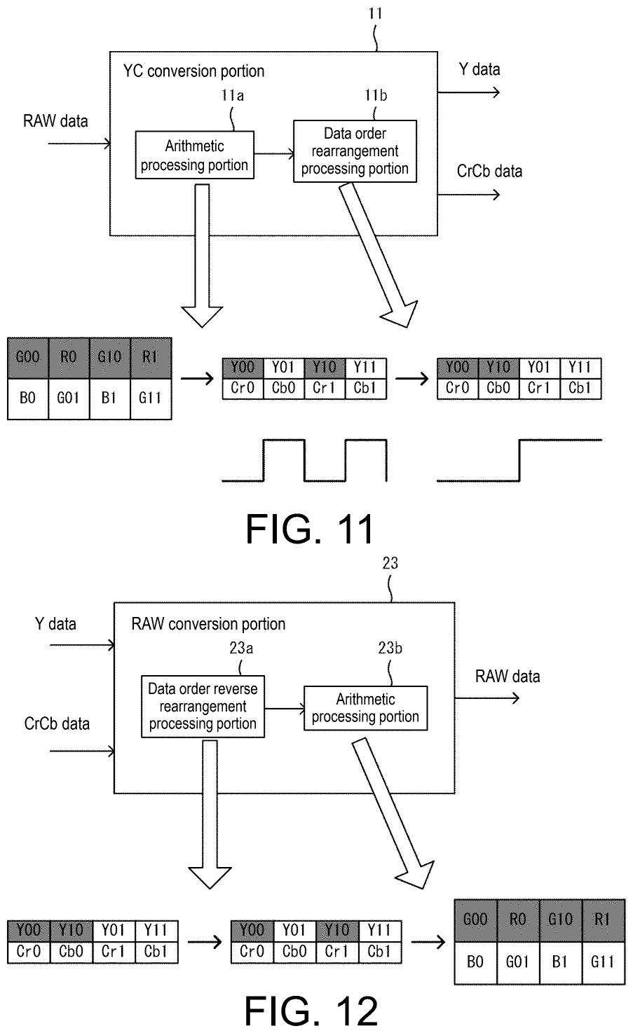

The video signal transmitting/receiving system of this embodiment is configured to resolve such problems. FIG. 11 is a diagram showing the functional configuration of the YC conversion portion 11 in the video signal transmitting device 10 of this embodiment. The hardware configuration of the YC conversion portion 11 is the same as in the first embodiment. While in the first embodiment, the YC conversion portion 11 only had the function of the arithmetic processing portion 11a, in this embodiment, the process of the data order rearrangement processing portion 11b, which is a newly added function, is performed by the processor 76.

In the video signal transmitting device 10 of this embodiment, the YC conversion portion 11 separates, for every plurality of units adjacent to each other in the horizontal direction, into two Y data groups: a first pixel Y data group where Y data of the first pixel of each of the plurality of units are continuously arranged, and a second pixel Y data group where Y data of the second pixel of each of the plurality of units are continuously arranged, and these are output as signals in the horizontal direction continuously in order starting from either one of the Y data groups. It is noted that in this embodiment, as an example, the case where the above process is performed for every two units adjacent to each other in the horizontal direction is described.

Specifically, the YC conversion portion 11 includes, as shown in FIG. 11, an arithmetic processing portion 11a and a data order rearrangement processing portion 11b. RAW data is input to the YC conversion portion 11 every two rows in the horizontal direction.

The arithmetic processing portion 11a performs YC422 conversion on the input RAW data to generate YC data. Specifically, the YC conversion portion 11 converts RAW data to YC data by YC422 conversion for each pixel block consisting of 8 pixels (4 pixels in the horizontal direction×2 pixels in the vertical direction) and obtains YC data for 4 pixels aligned in the horizontal direction, consisting of 8 signals: Y data of the first pixel (Y00 in the figure), Y data of the second pixel (Y01 in the figure), Y data of the third pixel (Y10 in the figure), and Y data of the fourth pixel (Y11 in the figure) in order from the beginning in one of the two rows in the horizontal direction; and Cb data (Cb0 in the figure) and Cr data (Cr0 in the figure) common to the first pixel and second pixel, and Cb data (Cb1 in the figure) and Cr data (Cr1 in the figure) common to the third pixel and fourth pixel in the other of the two rows in the horizontal direction.

There are no particular restrictions on the method of YC422 conversion at this time, and any method may be used, such as various existing conversion formulas or the simplified conversion formulas described below. In this embodiment, as an example, YC422 conversion is performed using the following simplified conversion formulas.

$$Y 00 = G 00$$

$$Y 01 = G 01$$

$$Y 10 = G 10$$

$$Y 11 = G 11$$

$$G 0 = ( G 00 + G 01 ) / 2$$

$$G 1 = ( G 10 + G 11 ) / 2$$

$$Y 0 = ( 5 G 0 + 2 R 0 + B 0 ) / 8$$

$$Y 1 = ( 5 G 1 + 2 R 1 + B 1 ) / 8$$

$$Cb 0 = B 0 - Y 0$$

$$Cb 1 = B 1 - Y 1$$

$$Cr 0 = R 0 - Y 0$$

$$Cr 1 = R 1 - Y 1$$

The data order rearrangement processing portion 11b separates the YC data generated by the arithmetic processing portion 11a into two Y data groups: a first pixel Y data group (Y00 and Y10 in the figure) where Y data of the first pixel of each of the plurality of units are continuously arranged, and a second pixel Y data group (Y01 and Y11 in the figure) where Y data of the second pixel of each of the plurality of units are continuously arranged, and these are output as signals in one of the horizontal direction rows continuously in order starting from either one of the Y data groups.

Further, the data order rearrangement processing portion 11b outputs the CbCr data as a signal in the other horizontal direction row without rearranging the same.

The RAW conversion portion 23 of the video signal repeating device 20 converts the YC data, which is digital data output from the ADC 22, into RAW data by performing a process that is the reverse of the YC conversion portion 11 of the video signal transmitting device 10. FIG. 12 is a diagram showing the functional configuration of the RAW conversion portion 23 in the video signal repeating device 20 of this embodiment. The hardware configuration of the RAW conversion portion 23 is the same as in the first embodiment described above. It is noted that in the first embodiment, the RAW conversion portion 23 only had the function of the arithmetic processing portion 23b, but in this embodiment, the process of the data order reverse rearrangement processing portion 23a, which is a newly added function, is performed by the processor 81.

The RAW conversion portion 23 includes, as shown in FIG. 12, a data order reverse rearrangement processing portion 23a and an arithmetic processing portion 23b. The data order reverse rearrangement processing portion 23a performs a reverse rearrangement process on the input YC data, which is the reverse of the rearrangement process done by the data order rearrangement processing portion 11b of the YC conversion portion 11. Next, the arithmetic processing portion 23b performs a conversion process, which is a process that is the reverse of the YC conversion process done by the arithmetic processing portion 11a of the YC conversion portion 11, on the YC data that has undergone the reverse rearrangement process, to obtain RAW data.

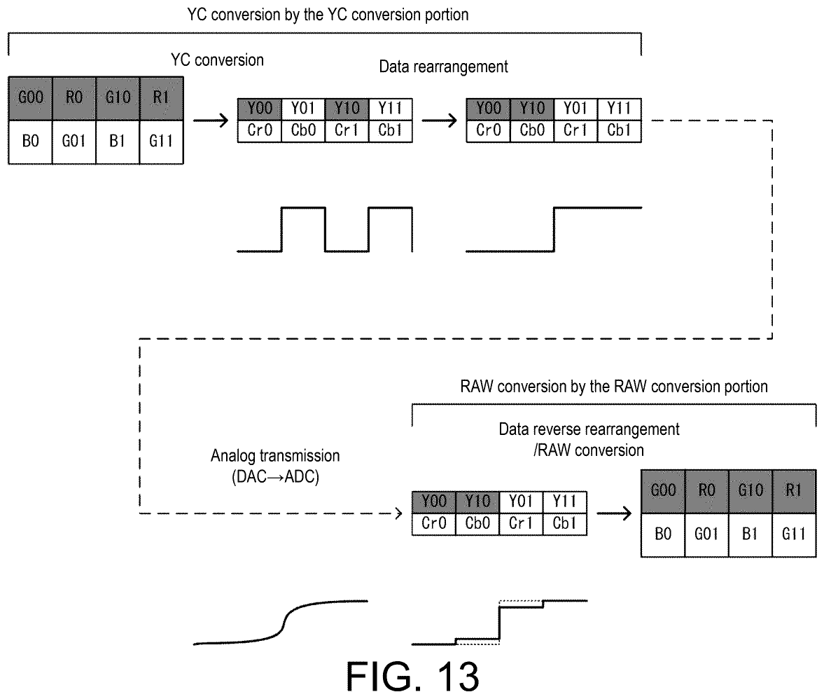

Next, the effects of the video signal transmitting/receiving system of this embodiment are described. FIG. 13 is a diagram showing the state of change in signal state when transmitting a video signal from the video signal transmitting device 10 of this embodiment to the video signal repeating device.

As shown in FIG. 13, in the video signal transmitting/receiving system of this embodiment, for every two units adjacent to each other in the horizontal direction, the YC data is separated into two Y data groups: a first pixel Y data group where Y data of the first pixel of each of the plurality of units are continuously arranged, and a second pixel Y data group where Y data of the second pixel of each of the plurality of units are continuously arranged, and the data is rearranged so that the signals in the horizontal direction are output consecutively starting from one of the Y data groups.

As a result, since the number of occurrences of steep changes in luminance is reduced, and the high-frequency components of the Y data are reduced, signal degradation is less likely to occur in the digital-to-analog conversion by the DAC 12 of the video signal transmitting device 10 and the analog-to-digital conversion by the ADC 22 of the video signal repeating device 20.

As a result, when the video signal repeating device 20 converts the YC data to obtain RAW data, it may improve image quality by suppressing edge blurring and bleeding at boundary areas.

It is noted that in this embodiment, as an example, the YC conversion portion 11 and the RAW conversion portion 23 perform the above-mentioned process for every two units adjacent to each other in the horizontal direction, but the above-mentioned data rearrangement process and reverse rearrangement process may be performed for every three or more units adjacent to each other in the horizontal direction.

### Third Embodiment

Next, the video signal transmitting/receiving system of the third embodiment is described. The video signal transmitting/receiving system of this embodiment differs from the video signal transmitting/receiving system 1 of the second embodiment in that the YC conversion portion 11 of the video signal transmitting device 10 and the RAW conversion portion 23 of the video signal repeating device 20 perform data rearrangement process and reverse rearrangement process for all units adjacent to each other in the horizontal direction of the YC data.

In the video signal transmitting/receiving system of this embodiment, the same reference numbers are assigned to the same components as in the video signal transmitting/receiving system 1 of the second embodiment, and descriptions are omitted unless particularly necessary.

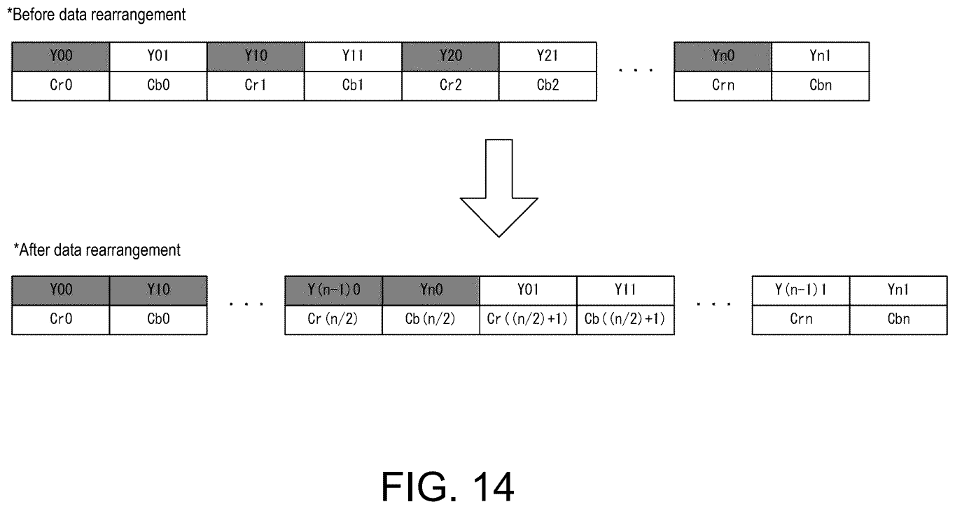

The following describes the rearrangement process of YC data in the video signal transmitting/receiving system of this embodiment. FIG. 14 is a diagram for describing the rearrangement process of YC data in the video signal transmitting/receiving system of this embodiment.

In the video signal transmitting device 10 of this embodiment, the YC conversion portion 11 separates, for all units adjacent to each other in the horizontal direction, into two Y data groups: a first pixel Y data group in which Y data of the first pixel of each of the plurality of units are continuously arranged, and a second pixel Y data group in which Y data of the second pixel of each of the plurality of units are continuously arranged, and these are output as signals in the horizontal direction continuously in order starting from either one of the Y data groups.

Specifically, the YC conversion portion 11 includes an arithmetic processing portion 11a and a data order rearrangement processing portion 11b. RAW data is input to the YC conversion portion 11 every two rows in the horizontal direction.

The arithmetic processing portion 11a performs YC422 conversion on the input RAW data to generate YC data. There are no particular restrictions on the method of YC422 conversion at this time, and any method may be used, such as various existing conversion formulas or the simplified conversion formulas described below. In this embodiment, as an example, YC422 conversion is performed using the following simplified conversion formulas. Here, “n” is the total number of all units adjacent to each other in the horizontal direction.

$$Y 00 = G 00$$

$$Y 01 = G 01$$

$$G 0 = ( G 00 + G 01 ) / 2$$

$$Y 0 = ( 5 G 0 + 2 R 0 + B 0 ) / 8$$

$$Cb 0 = B 0 - Y 0$$

$$Cr 0 = R 0 - Y 0$$

$$.$$

$$.$$

$$.$$

$$Yn 0 = Gn 0$$

$$Y n 1 = Gn 1$$

$$Gn = ( G n 0 + Gn 1 ) / 2$$

$$Yn = ( 5 Gn + 2 Rn + Bn ) / 8$$

$$Cbn = Bn - Yn$$

$$Crn = Rn - Yn$$

The data order rearrangement processing portion 11b separates the YC data generated by the arithmetic processing portion 11a into two Y data groups: a first pixel Y data group (Y00 to Yn0 in the figure) in which the Y data of the first pixel of each of the plurality of units are continuously arranged, and a second pixel Y data group (Y01 to Yn1 in the figure) in which the Y data of the second pixel of each of the plurality of units are continuously arranged, and these are output as signals in one of the horizontal direction rows continuously in order starting from either one of the Y data groups.

Further, the data order rearrangement processing portion 11b outputs the CbCr data as a signal in the other horizontal direction row without rearranging the same.

The RAW conversion portion 23 of the video signal repeating device 20 converts the digital data output from the ADC 22 into RAW data by performing a process that is the reverse of the YC conversion portion 11 of the video signal transmitting device 10.

In this way, by performing data rearrangement process and reverse rearrangement process for all units adjacent to each other in the horizontal direction in the YC data, compared to performing data rearrangement process and reverse rearrangement process for only some of the units adjacent to each other in the horizontal direction in the YC data, the number of occurrences of steep changes in luminance is further reduced, and the high-frequency components of the Y data are reduced. As a result, signal degradation is less likely to occur in the digital-to-analog conversion by the DAC 12 of the video signal transmitting device 10 and in the analog-to-digital conversion by the ADC 22 of the video signal repeating device 20.

As a result, when the video signal repeating device 20 converts the YC data to obtain RAW data, it may further suppress edge blurring and boundary bleeding, thereby further improving image quality.

### Modified Example

The disclosure has described the video signal transmitting/receiving system 1 of the embodiment, but the disclosure is not limited to the above embodiment. In addition to the above, within the scope of not departing from the technical spirit of the disclosure, appropriate modifications may be made to the described content and illustrated content shown above, such as deleting unnecessary parts, adding new elements, or replacing elements.

For example, in the RGB conversion portion 24 of the video signal repeating device 20, when converting RAW data to RGB, the RGB conversion may be performed without carrying out the demosaic process.

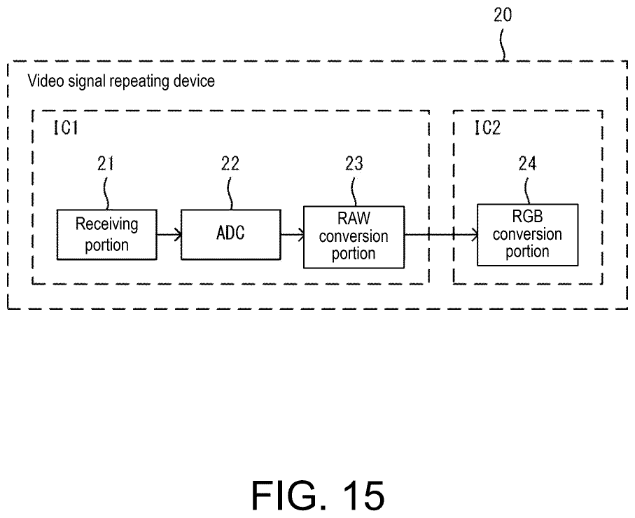

Further, as shown in FIG. 15, in the video signal repeating device 20, the RGB conversion portion 24 may be configured by an integrated circuit IC2 that is different from the integrated circuit IC1 constituting the receiving portion 21, the ADC 22, and the RAW conversion portion 23.

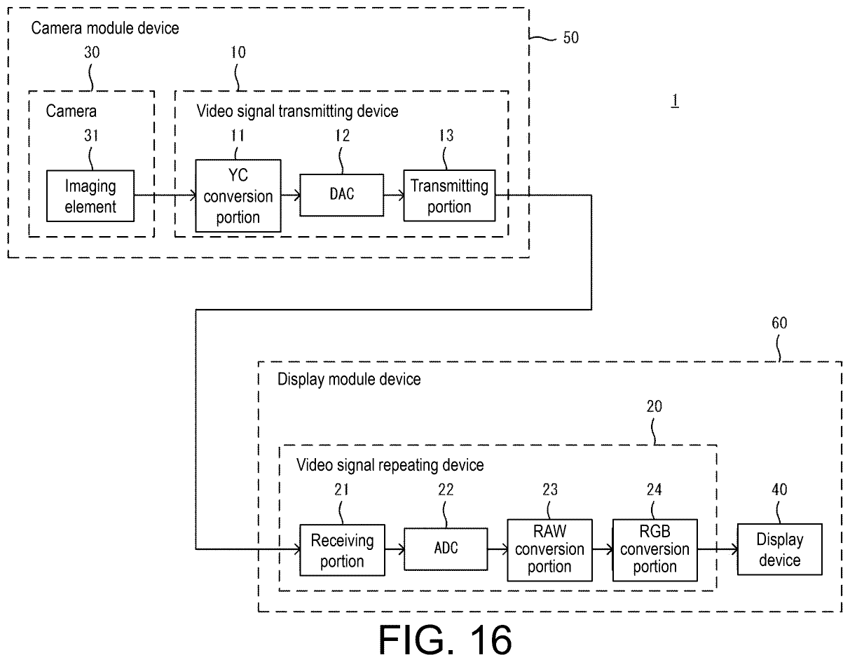

Further, as shown in FIG. 16, the video signal transmitting/receiving system 1 may include a camera module device 50 in which the camera 30 and the video signal transmitting device 10 are integrated, and a display module device 60 in which the video signal repeating device 20 and the display device 40 are integrated.

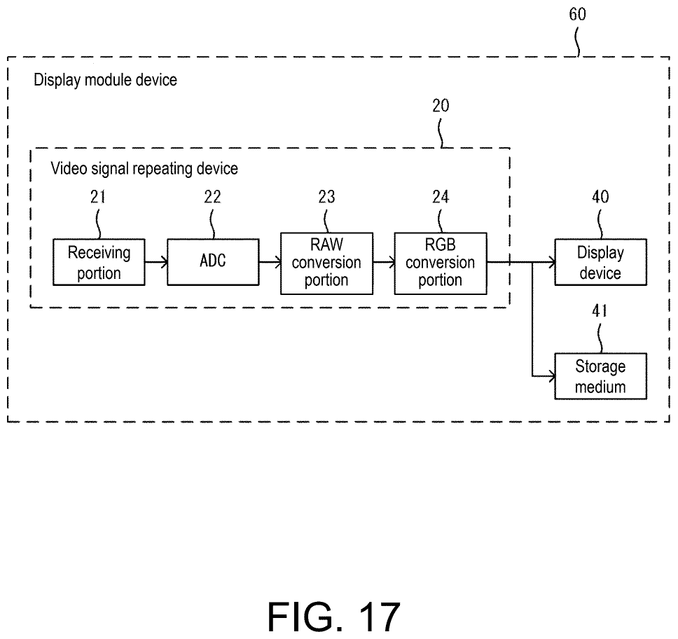

Further, as shown in FIG. 17, the display module device 60 may output the signal output from the video signal repeating device 20 to both the display device 40 and the storage medium 41. Further, the display module device 60 may output the signal output from the video signal repeating device 20 only to the storage medium 41.

The storage medium 41 may be any type of medium, for example, ROM (Read Only Memory), RAM (Random Access Memory), flash memory, USB (Universal Serial Bus) memory, SSD (Solid State Drive), or HDD (Hard Disk Drive).

### [Appendix]

The following describes preferred embodiments of the disclosure.

### (Appendix 1)

A video signal transmitting device that includes: a YC conversion portion to which RAW data output from an imaging element by performing imaging is input, and configured to convert RAW data into YC data consisting of luminance data, first chrominance data, and second chrominance data for output;
a digital-to-analog conversion portion configured to convert YC data output from the YC conversion portion into an analog signal for output; and
an analog transmitting portion configured to transmit an analog signal converted by the digital-to-analog conversion portion to an external device.

### (Appendix 2)

In the video signal transmitting device according to Appendix 1, RAW data is video data that has one red pixel, one blue pixel, and two green pixels as one unit, and the YC conversion portion converts input RAW data into first luminance data, second luminance data, first chrominance data, and second chrominance data for each unit, separates converted data into a luminance data group and a chrominance data group, and sequentially outputs separated luminance data group and chrominance data group as YC data to the digital-to-analog conversion portion.

### (Appendix 3)

In the video signal transmitting device according to Appendix 2, the YC conversion portion serializes and outputs separated luminance data group and chrominance data group respectively, and includes a data order rearrangement processing portion that rearranges and serializes a data order of first luminance data and second luminance data between predetermined units.

### (Appendix 4)

In the video signal transmitting device according to any one of Appendices 1 to 3, the YC conversion portion converts the RAW data into YC data in YC422 format.

### (Appendix 5)

In the video signal transmitting device according to any one of Appendices 1 to 4, the YC conversion portion converts the RAW data into YC data in YC422 format using a RAW clock corresponding to a signal pitch of the RAW data and a YC clock with a frequency of ½ times the RAW clock.

### (Appendix 6)

A video signal repeating device that includes:
a receiving portion configured to receive an analog signal transmitted from a video signal transmitting device according to Appendix 1;
an analog-to-digital conversion portion configured to convert an analog signal received by the receiving portion into YC data for output; and
a RAW conversion portion configured to convert YC data output from the analog-to-digital conversion portion into RAW data for output.

### (Appendix 7)

In the video signal repeating device according to Appendix 6, the RAW conversion portion, in a case where a data order of luminance data of YC data has been rearranged, includes a data order reverse rearrangement processing portion that rearranges luminance data back to a data order before rearrangement, and converts YC data rearranged by the data order reverse rearrangement processing portion into RAW data.

### (Appendix 8)

In the video signal repeating device according to Appendix 6 or 7, the RAW conversion portion converts YC data output from the analog-to-digital conversion portion into RAW data for output using a RAW clock corresponding to a signal pitch of the RAW data and a YC clock with a frequency of ½ times the RAW clock.

### (Appendix 9)

The video signal repeating device according to any one of Appendices 6 to 8 further includes an RGB conversion portion that converts RAW data output from the RAW conversion portion into RGB data for output.

### (Appendix 10)

In the video signal repeating device according to Appendix 9, the RGB conversion portion applies a demosaic process in response to converting RAW data into RGB data.

### (Appendix 11)

In the video signal repeating device according to Appendix 9 or 10, in a case where YC data in YC422 format is output from the analog-to-digital conversion portion, the RAW conversion portion converts YC data in YC422 format to RAW data in RAW8 format, and the RGB conversion portion converts RAW data in RAW8 format to RGB data in RGB888 format.

### (Appendix 12)

In the video signal repeating device according to any one of Appendices 9 to 11, the RGB conversion portion is configured by an integrated circuit different from an integrated circuit constituting the receiving portion, the analog-to-digital conversion portion, and the RAW conversion portion.

### (Appendix 13)

A video signal transmitting/receiving system that includes:
a camera having the imaging element;
a video signal transmitting device according to any one of Appendices 1 to 5;
a video signal repeating device according to any one of Appendices 6 to 12; and
a display device configured to display a video based on a signal output from the video signal repeating device.

### (Appendix 14)

The video signal transmitting/receiving system according to Appendix 13 that includes: a camera module device in which the camera and the video signal transmitting device are integrated; and a display module device in which the video signal repeating device and the display device are integrated.

### (Appendix 15)

In the video signal transmitting/receiving system according to Appendix 14, the display module device outputs a signal output from the video signal repeating device to a storage medium.

What is claimed is:

1. A video signal transmitting device, comprising:
a YC conversion portion to which RAW data output from an imaging element by performing imaging is input, and configured to convert RAW data into YC data consisting of luminance data, first chrominance data, and second chrominance data for output;
a digital-to-analog conversion portion configured to convert YC data output from the YC conversion portion into an analog signal for output; and
an analog transmitting portion configured to transmit an analog signal converted by the digital-to-analog conversion portion to an external device.

2. The video signal transmitting device according to claim 1, wherein RAW data is video data that has one red pixel, one blue pixel, and two green pixels as one unit, and
the YC conversion portion converts input RAW data into first luminance data, second luminance data, first chrominance data, and second chrominance data for each unit, separates converted data into a luminance data group and a chrominance data group, and sequentially outputs separated luminance data group and chrominance data group as YC data to the digital-to-analog conversion portion.

3. The video signal transmitting device according to claim 2, wherein the YC conversion portion serializes and outputs separated luminance data group and chrominance data group respectively, and comprises a data order rearrangement processing portion that rearranges and serializes a data order of first luminance data and second luminance data between predetermined units.

4. The video signal transmitting device according to claim 1, wherein the YC conversion portion converts the RAW data into YC data in YC422 format.

5. The video signal transmitting device according to claim 1, wherein the YC conversion portion converts the RAW data into YC data in YC422 format using a RAW clock corresponding to a signal pitch of the RAW data and a YC clock with a frequency of ½ times the RAW clock.

6. A video signal repeating device, comprising:
a receiving portion configured to receive an analog signal transmitted from a video signal transmitting device according to claim 1;
an analog-to-digital conversion portion configured to convert an analog signal received by the receiving portion into YC data for output; and
a RAW conversion portion configured to convert YC data output from the analog-to-digital conversion portion into RAW data for output.

7. The video signal repeating device according to claim 6, wherein the RAW conversion portion, in a case where a data order of luminance data of YC data has been rearranged, comprises a data order reverse rearrangement processing portion that rearranges luminance data back to a data order before rearrangement, and converts YC data rearranged by the data order reverse rearrangement processing portion into RAW data.

8. The video signal repeating device according to claim 6, wherein the RAW conversion portion converts YC data output from the analog-to-digital conversion portion into RAW data for output using a RAW clock corresponding to a signal pitch of the RAW data and a YC clock with a frequency of ½ times the RAW clock.

9. The video signal repeating device according to claim 6, further comprising an RGB conversion portion that converts RAW data output from the RAW conversion portion into RGB data for output.

10. The video signal repeating device according to claim 9, wherein the RGB conversion portion applies a demosaic process in response to converting RAW data into RGB data.

11. The video signal repeating device according to claim 9, wherein in a case where YC data in YC422 format is output from the analog-to-digital conversion portion,
the RAW conversion portion converts YC data in YC422 format to RAW data in RAW8 format, and
the RGB conversion portion converts RAW data in RAW8 format to RGB data in RGB888 format.

12. The video signal repeating device according to claim 9, wherein the RGB conversion portion is configured by an integrated circuit different from an integrated circuit constituting the receiving portion, the analog-to-digital conversion portion, and the RAW conversion portion.

13. A video signal transmitting/receiving system, comprising:
a camera having an imaging element;
a video signal transmitting device, comprising:
a YC conversion portion to which RAW data output from an imaging element by performing imaging is input, and configured to convert RAW data into YC data consisting of luminance data, first chrominance data, and second chrominance data for output;
a digital-to-analog conversion portion configured to convert YC data output from the YC conversion portion into an analog signal for output; and
an analog transmitting portion configured to transmit an analog signal converted by the digital-to-analog conversion portion to an external device;
a video signal repeating device, comprising:
a receiving portion configured to receive an analog signal transmitted from the video signal transmitting device;
an analog-to-digital conversion portion configured to convert an analog signal received by the receiving portion into YC data for output; and
a RAW conversion portion configured to convert YC data output from the analog-to-digital conversion portion into RAW data for output; and
a display device configured to display a video based on a signal output from the video signal repeating device.

14. The video signal transmitting/receiving system according to claim 13, comprising:
a camera module device in which the camera and the video signal transmitting device are integrated; and
a display module device in which the video signal repeating device and the display device are integrated.

15. The video signal transmitting/receiving system according to claim 14, wherein the display module device outputs a signal output from the video signal repeating device to a storage medium.
